(19) United States
(12) Patent Application Publication
(10) Pub. No.: US 2009/0103891 A1
(43) Pub. Date: Apr. 23, 2009

(54) Digital video recorder with advanced user functions and network capability

(76) Inventor: Scott C Harris, Rancho Santa Fe, CA (US)

Correspondence Address: SCOTT C HARRIS, P O BOX 927649, SAN DIEGO, CA, 92192, US

(21) Appl. No.: 11/537,407

(22) Filed: Sep. 29, 2006

(51) Int. Cl. H04N 5/91; H04N 7/26; H04N 5/44

(52) U.S. Cl. 386/83; 386/124; 348/734; 348/E05.096

(57) ABSTRACT

A digital video recording system that uses a first digital video recording process to record at least one video program, and to form a list of recorded programs. A connection over a network is made to at least one other digital video recording process. A list is formed that indicates programs that have been recorded on both the first digital video recording process and on the other digital video recording process that is connected over the network.

### BACKGROUND

Digital video recorders are well known as devices which receives video, for example from an analog or digital source, and record video information digitally. Advantages of this system include the ability to provide an ordered list of the items which have been recorded in this way, allowing a user to scroll anywhere through this ordered list and select any program to be played.

### SUMMARY

The present application teaches a system which enables advanced functions in a digital video recorder.

### BRIEF DESCRIPTION OF THE DRAWINGS

FIG. 1 shows a block diagram of the DVR;

FIG. 2 a flowchart; and

FIG. 3 shows a screen with program lists.

### DETAILED DESCRIPTION

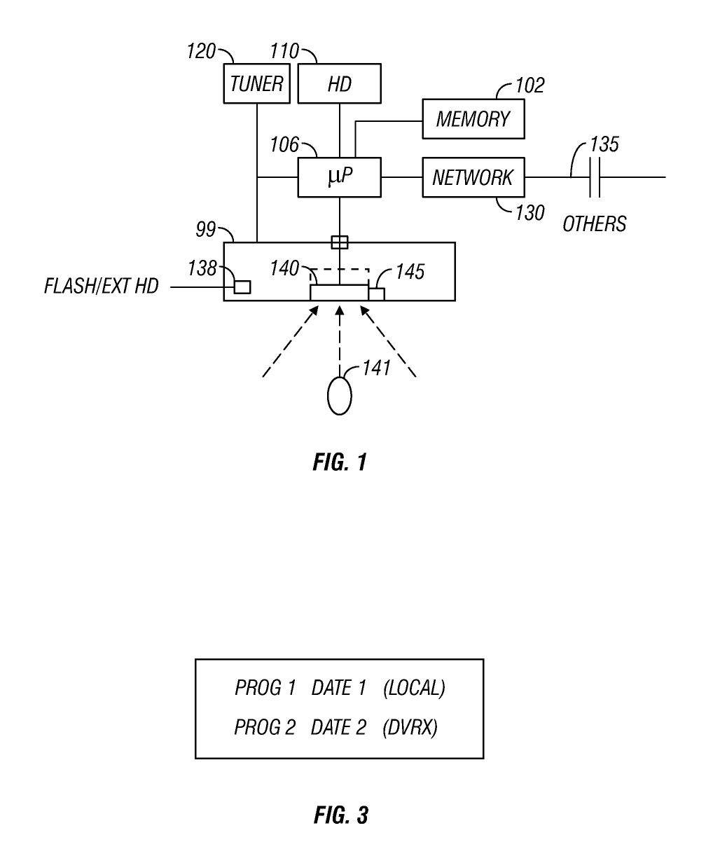

FIG. 1 illustrates a exemplary hardware layout of a digital video recorder or DVR 99. A microprocessor 100 operates according to stored instructions. The stored instructions may be in local memory 102, or may be on a hard drive 110. The hard drive 110 stores the programs that are received by the video recorder under the supervision of the microprocessor 100. The programs that are received are received through a tuner input 120, which may be an interface to a cable box, a satellite system, an analog tuner or other device that receives video programming. The programs are then digitized under control of the microprocessor 100 unless already in digital form. The digital information is stored on the hard drive, and appropriately cataloged for later use.

A network connection 130 may also be provided, to allow connection to an external network 135 such as the Internet. The external network may also connect to other local DVRs, to allow transfer of programs between the local DVRs. A connection, such as a USB port, may also permit the connection of a flash memory or other kind of external hard drive, which includes additional storage allowing programs recorded on one DVR to be played on either a different DVR or may simply extend the storage capabilities of the DVR.

Convenience dictates that the DVR be controllable by a remote control. An infrared port 140 may sense signals from an external infrared remote 141. These signals may include play, stop, cause, fast-forward, and the like.

Because of the usual form factor for a remote, it is conventionally been infeasible to include keyboard like functions. Arrow keys, and up and down keys are conventionally used on the remote. However, this leads to an interface logjam, especially when the DVR has the capability of storing large numbers of programs. The programs may be accessed via a list, but when the list is long, it may be difficult to find those programs.

For example, assume that the DVR may have 10 programs on the page, and 300 programs total. This means that finding a program may require 30 initiations of the page down button in order to get to the right page.

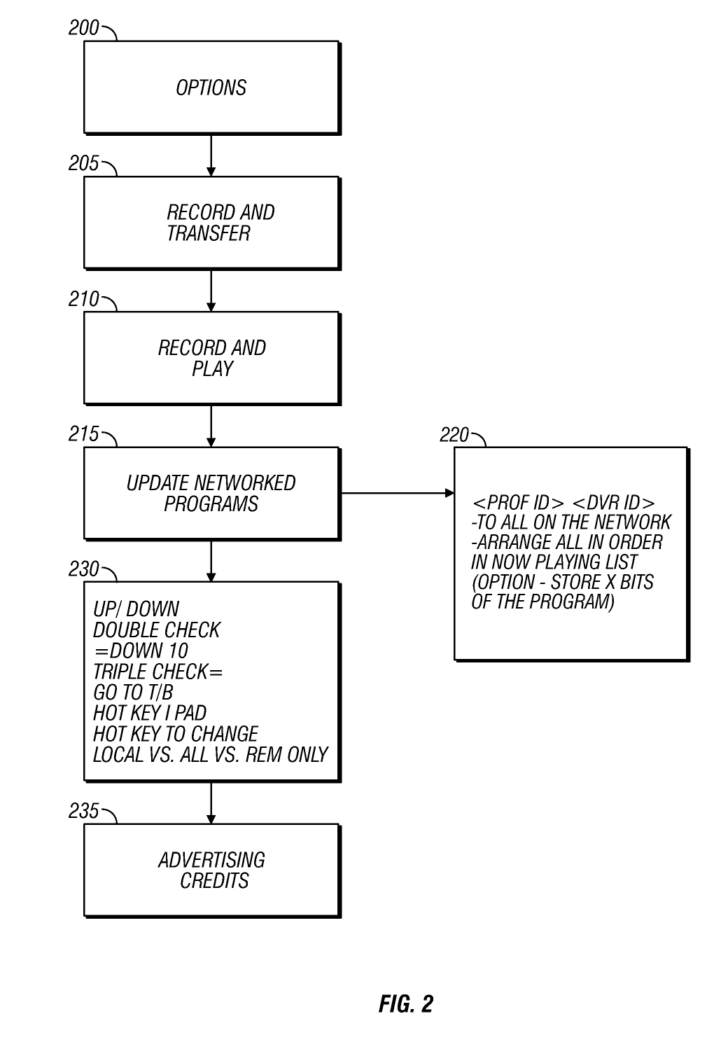

FIG. 2 illustrates an operation which may be carried out as part of the options in an improved DVR. The option screens shown as 200 may be in additional to the usual record, play, schedule type operations which the DVR conventionally includes. The DVR may include an additional sensor 145 which may be an ultrasonic or infrared sensor that detects movement and/or the presence of a user.

At 205, a first operation is enabled, entitled “record and transfer”. As explained above, the network connection 130/135 may connect to other DVRs, for example other DVRs on the same local network as the main DVR 99. Alternatively, there may be simply network storage devices, such as network hard drives, that are connected to the device. However, recording is conventionally only locally done on the local hard drive. The record and transfer option 205 allows the system to record the program, and then, when finished, to transfer that program to a different DVR or storage facility. This may include the ability to erase the transfer recording after transfer, or it may simply command the recording be transferred to the other DVR, so that both DVRs retain a copy.

For example, in a household, multiple users may watch TV. They may watch on different TVs, and each TV may have its own DVR. However, assume that two people in the household want to see the same show, but they often watch TV separately. They could each independently record the program, or set an option where the program is recorded, and then automatically transferred. In this way, each user can watch the program and then delete it, knowing that the program has been automatically transferred to the other DVR.

210 illustrates a different feature, referred to as record and play. This feature automatically plays the program at either of both of a specified time, and/or the presence of a human. For example, assume that the DVR always records the Evening News. The users can watch the news when they get home from work. With this option, therefore, the DVR can be set to automatically play the evening news when 1) it is after the time for the evening news, 2) the television has been turned on, and 3) the DVR's sensor 140 and/or 145 senses the presence of one or more humans in its general vicinity.

In one aspect, the DVR may use the infrared room remote-sensing port as an infrared sensing port, to detect a heat source of a signature and type that indicates a human being. The sensing may require that the human be in the area for five minutes or more.

In addition, the record and play of 210 may be any subset of the above, for example, it may record and play any time the DVR senses that the television has been turned on. This may be sensed, in turn, by the infrared port 140 sensing the on indication from the television remote, indicating.

A network program operation is then initiated at 215. In conventional DVRs, each DVR stores its own list of programs, and the DVR may connect to other DVRs to get their list. However, in an embodiment, the display may be modified so that the DVR can display not only its local programs, but in fact a complete list of all programs available over the network: both networked and not networked. The network programs, for example, may be shown in a different way such as in a different font, in a different color, or with an indication that they are available from the network. However, the network programs are shown in the same list as the local programs, sorted, for example, either by time or alphabetically or in any other way.

In order to minimize the time it takes to arrange these programs, the programs are updated for example once a day or once every four hours, so that an index is locally stored that has information about the non-local programs. That index may include the local programs or may be combined with the local programs. Since the information is indexed, an almost immediate list of all programs including both local and nonlocal programs can be provided as shown in FIG. 3.

120 illustrates some aspects of the update of the network program. For example, 220 shows a program ID which may be a number indicative of the program or may be the actual title and date of the program to be displayed. The program ID may also include a brief description of the program. This is followed by the DVR ID which may be a unique ID or may be some other information identifying the DVR on the network. This information may be sent to all DVRs on the network. All are arranged in order on the list of programs, e.g., the “now playing” list on a Tivo™ device.

According to an alternative option, some part of the program may be locally stored on each of the DVRs also. For example, the first three minutes of each of the networked, nonlocal programs may be locally stored. This may be useful to enable a user to determine quickly if they have seen the show or not, and/or if they are interested in later seeing the show. It may also provide a three minute “head start”, in case the user wants to start watching while the show is transferring.

Any time a program is removed from the device on which it is stored, the next update will remove the programs (and whatever stored bits of that program may be available on the other DVR) from the list of programs.

At 230, some user interface additions are obtained. Instead of page up and page down, the user is enabled to double-click to go 10 pages down, and to triple click to go to the top or bottom. A first hotkey is enabled to change the program entry mode to a predictive text input technique that assigns multiple letters to the numbers on the remote. Examples of such techniques include “itap” and “T9”. This allows typing out the name of the show being searched for using the number keys of the remote. As conventional in phones, the numbers can be assigned with 1 for special characters, 2 for abc, 3 for def, 4 for ghi, 5 for jkl, 6 for mno, 7 for pqrs, 8 for tuv, and 9 for wxyz, and some other key for a space. The algorithm attempts to form words as the numbers are input. The words may appear on the video screen, and arrow keys may be used to scroll through different choices and/or sets formed from the entered numbers. This does not change the form factor of the remote, since remotes conventionally include number keys anyway, to allow changing channels.

A second hot key is enabled to change between viewing only those programs in local storage, versus all including local and remote, and possibly also only those in remote storage.

While the above describes double-click to go down five pages, it should be understood that the double-click could go up or down five pages instead of 10 pages, or in fact n pages, where n is some number greater than 1, and that other keys on the remote can be used for this feature.

235 refers to an option called advertising credits. The programs may of course be stored on a central server. However, many systems have avoided trying to transfer these programs from the central server, because of fear of copyright infringement. Based on at least one Supreme Court case, it is possible to record a program off of live air, but recording a program from a central server may not be fair use.

At the same time, however, many program producers are concerned with the effect of DVRs on the watching of commercials. With the DVR, it becomes possible to fast-forward over the commercials, leading to the belief that many users do not watch the commercials at all.

A system of advertising credits is used in 235 which addresses these issues. According to this system, the programs are stored on a central server. Basically, every program may be stored on the server, and is distributed along with advertising. The distribution, however, is done in a way that prevents others from watching the programs without commercials.

In an embodiment, the programs are transferred to the DVR, e.g., over a network, either in real time, non-real-time, or by a peer-to-peer connection as described in my copending application number ______. However, the programs that are transferred are not completely watchable. A system of advertising credit is used. The system allows users to watch a certain amount of the program, but after that amount of the program, a commercial must be watched. The DVR viewing program requires that the commercial must be played before the user can watch any more of the program.

Alternatively, the system may allow the user to watch the commercial, obtain credits, at the end of each commercials indicate that one can go to the next one, and take some action that allows the advertiser to realize that the user has actually been played. According to another embodiment, the user sensor may be used to monitor the people being actually present during the commercials.

This is a sort of quid pro quo system: the user may be allowed to download television programs at a time when they are not actually recording, in return for the user agreeing to watch non-real-time commercials. The networks and advertisers might agree that this constitutes fair use of the programs, since it forces the watcher to watch the commercials, as was intended by the broadcaster.

The general structure and techniques, and more specific embodiments which can be used to effect different ways of carrying out the more general goals are described herein.

Although only a few embodiments have been disclosed in detail above, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of DVRs may be modified in this way. Some of the techniques, and particularly the remote modifying techniques, may be used in non-DVR applications.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A method, comprising:
using a first digital video recording process to record at least one video program, and to form a list of recorded programs;
connecting over a network to at least one other digital video recording process; and
forming said list to indicate programs that have been recorded on both said first digital video recording process and on said at least one other digital video recording process that is connected over the network.

2. A method as in claim 1, further comprising maintaining a cache listing programs available on said at least one other digital video recording process associated with said first digital video recording process, and displaying said programs based on said cache without requiring connection to said at least one other digital video recording process.

3. A method as in claim 1, further comprising storing some part of the programs available on said at least one other digital video recording process associated with said first digital video recording process and enabling a preview of said programs.

4. A method as in claim 1, wherein said programs are stored in a list, and said list is accessible using at least one arrow key, and further enabling an action which goes up or down by more than one page.

5. A method as in claim 1, wherein said programs are stored in a list, and further comprising allowing entry of names of said programs into the number pad of a remote control using a predictive text input algorithm.

6. A method as in claim 4, wherein said action goes up or down by n pages, where n is some number greater than 1.

7. A method as in claim 4, wherein said action goes down to one of a bottom or top of a list.

8. A method as in claim 1, further comprising enabling an action and whereby the recorder can automatically transfer a program that it is recording to another DVR.

9. An apparatus, comprising:
a first digital video recorder that records at least one video program, stores the recorded program, said recorder having a network connection that allows connecting to at least one other recorder that stores at least one other recorded program, and forms a list to indicate programs that have been recorded on both said first digital video recorder process and said at least one other digital video recorder.

10. An apparatus as in claim 9, wherein said first digital video recorder maintains a cache listing programs available on said at least one other digital video recorder, and displaying said list from said cache without requiring connection to said at least one other digital video recorder.

11. An apparatus as in claim 9, wherein said first digital video recorder also stores some part less than all, of the programs available on said at least one other digital video recorder process.

12. An apparatus as in claim 9, wherein said programs are stored in a list, and further comprising an interface to a remote control that controls navigation on said list using at least one arrow key, and further enabling an action which goes up or down by more than one page.

13. An apparatus as in claim 9, wherein said programs are stored in a list, and further comprising an interface to a remote control with number keys used to control channel selection, and that controls navigation on said list using entry of names of said programs into the number pad of the remote control using a predictive text input algorithm.

14. An apparatus as in claim 9, further comprising at least one sensor on said digital video recorder, sensing the presence of a person, and carrying out at least one operation based on said sensing.

15. An apparatus, comprising:
a remote control for a video selection device including number keys allowing selection of channels, and a selectable mode which allows entry of program names into the number pad of the remote control using a predictive text input algorithm that converts said number entry into text names.

16. An apparatus as in claim 15, wherein said remote control controls a first digital video recorder that records at least one video program.

17. An apparatus as in claim 16, wherein said remote control enables selection of viewing either programs only on said first digital video recorder, or also those on other recorders connected to said at least one other digital video recorder.

18. An apparatus as in claim 17, wherein said selection includes first digital video recorder maintains a cache listing programs available on said at least one other digital video recorder, and wherein said selection enables displaying without requiring connection to said at least one other digital video recorder.

19. An apparatus as in claim 18, wherein said first digital video recorder also stores some part less than all, of the programs available on said at least one other digital video recorder process.
